(19) United States
(12) Patent Application Publication
(10) Pub. No.: US 2010/0117850 A1
(43) Pub. Date: May 13, 2010

(54) PRECISELY SYNCHRONIZED NOTIFICATION SYSTEM

(76) Inventors: Robert McCaslin, Henderson, NV (US); Steven F. Meadows, Temecula, CA (US)

Correspondence Address: Pepper Hamilton LLP, 400 Berwyn Park, 899 Cassatt Road, Berwyn, PA, 19312-1183, US

(21) Appl. No.: 12/613,024

(22) Filed: Nov. 5, 2009

Related U.S. Application Data
(60) Provisional application No. 61/112,661, filed on Nov. 7, 2008.

(51) Int. Cl. G08B 5/00

(52) U.S. Cl. 340/815.4

(57) ABSTRACT

A system for producing a notification. The system includes a control device that includes a processor, a master clock operably connected to the processor and configured to produce a master clock signal, a user interface operably connected to the processor and configured to generate an operational sequence based upon a user input, and a transmitter operably connected to the processor and configured to transmit the master clock signal and the operational sequence. The system further includes a plurality of output devices configured to establish a connection with the control device, to receive the master clock signal and the operational sequence via the established connection, and to produce a synchronized notification based upon the master clock signal and the operational sequence. The synchronized notification may include flashing lights, audible sounds, or other similar displays.

### CROSS-REFERENCE TO RELATED APPLICATIONS

This application claims the priority benefit of U.S. Provisional Application No. 61/112,661 filed Nov. 7, 2008, which is hereby incorporated by reference in its entirety.

### FIELD OF THE INVENTION

The present invention presents a system for producing a notification.

### BACKGROUND

The present disclosure relates to a notification system. More specifically, the present disclosure relates to notification system having multiple programmable display devices.

Typically, during an accident or emergency, various emergency service providers need to provide a visual or audible warning of the accident. Several alternatives exist; however, each alternative has numerous drawbacks. One simple visual warning is a road flare. Road flares burn brightly and emit a light warning for redirecting pedestrians or traffic away from an accident scene. However, road flares are less useful during the day or during inclement weather, cannot be used in dry areas or areas having a lot of shrubs or brush near the road for threat of fire, are environmentally hazardous, and have a relatively short lifespan.

A second alternative is an electronic blinking light or beacon. These beacons can be set to continuously emit a light or to blink at various speeds. Multiple beacons may be arranged such that they redirect pedestrians or traffic away from an accident scene. However, beacons have limited functionality, and are difficult to arrange when using multiple beacons to form a display pattern, such as a blinking arrow or a running light pattern.

### SUMMARY

The invention described in this document is not limited to the particular systems, methodologies or protocols described, as these may vary. The terminology used herein is for the purpose of describing particular embodiments only, and is not intended to limit the scope of the present disclosure.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In one general respect, the embodiments disclose a system for producing a notification. The system includes a control device that includes a processor, a master clock operably connected to the processor and configured to produce a master clock signal, a user interface operably connected to the processor and configured to generate an operational sequence based upon a user input, and a transmitter operably connected to the processor and configured to transmit the master clock signal and the operational sequence. The system further includes a plurality of output devices configured to establish, a connection with the control device, to receive the master clock signal and the operational sequence via the established connection, and to produce a synchronized notification based upon the master clock signal and the operational sequence.

In another general respect, the embodiments disclose a method for producing a synchronized notification on a plurality of output devices. The method includes establishing a connection between a control device and the plurality of output devices, receiving user input at the control device, generating a master clock signal at the control device, generating a operational sequence at the control device based upon the user input, transmitting the master clock signal and the operational sequence from the control device to the plurality of output devices, and displaying a synchronized notification on the plurality of output devices based upon the master clock signal and the operational sequence.

### BRIEF DESCRIPTION OF THE DRAWINGS

Aspects, features, benefits and advantages of the present invention will be apparent with regard to the following description and accompanying drawings, of which:

FIG. 1 illustrates an exemplary notification system according to an embodiment;

FIG. 2 illustrates a second exemplary notification system according to an embodiment;

FIG. 3 illustrates a third exemplary notification system according to an embodiment;

FIG. 4 illustrates an exemplary process for synchronizing various components of an exemplary notification system according to an embodiment;

FIG. 5 illustrates an exemplary system include multiple notification systems in communication with one another according to an embodiment; and

FIG. 6 illustrates an exemplary battery charging arrangement according to an embodiment.

### DESCRIPTION OF EMBODIMENTS

The present disclosure relates to synchronizing two or more independent, autonomous output devices, such as lights, speakers, or flags, to flash, emit an audible sound, speak, or wave in a programmed sequence. Each independent, autonomous unit may synchronize with other identical autonomous units via a control device and a series of synchronized clocks without the use of any inter-device feedback system. Therefore, the output devices may operate independently, but work collectively to produce a synchronized pattern.

A group of two or more synchronized, autonomous output devices may be set to flash, speak, or wave at the same interval or at pre-defined intervals. The output devices may be synchronized by sharing a common time base clock (accurate oscillator) that is reset to zero or synchronized to match the clock of the control device common time base clock by a remote signal (which may be, but is not limited to, an infrared, radio frequency, Bluetooth, or audio signal). The output device may include of a light, a sound, a flag, an electronic road flare, or the like that can be detected by a user or a passing observer.

The time base clock may be used to control the output device. Such a clock may use a crystal or liquid crystal (LC) circuit as its precise and stable time base. Each output device may have a sequence timer that may indicate to the lights, or other output, precisely when to turn on or off. A control device may remotely send a signal to each output device to reset and program the base clock.

In one exemplary embodiment, the output devices may flash on and off at the same time, producing a clearly visible, straight-line visual effect. The flash rate may be determined by the color of light being illuminated. The eye responds to colors at different rates. For example, green is the most visible and therefore requires a shorter flash time to see its full intensity. Blue is, the most difficult to see. As such, it requires a slower flash rate to achieve the greatest visual effect. Matching the flash rate with the color may reduce the power consumption and increase the battery life of the individual output devices.

A dual flash (one colored light flashes, then a different colored light flashes) in a clear dome may be implemented as well. The same circuit may drive the multiple lights, such as light-emitting diodes (“LEDs”) of different colors or one multicolor LED, or liquid crystal diode (“LCD”). For example, the output devices may all flash red, and then in the next flash, may all flash blue. It should be noted that more than two colors of lights may be used.

In an alternate embodiment, the lights, speakers, or flags, may be programmed in a chase mode, creating an illusion of movement. A user may use a control device having a user interface to program the chase mode. Each output device may have an electronic serial number stored in memory that tells the output device when to flash in reference to the common time clock utilized by the output devices. The control device may reset the clock in each output device to zero or synchronize to match the clock of the control device common time base clock to electronically synchronize each output device, and then may program each individual output device according to its electronic serial number, thereby instructing each output device when to flash. For example, a first output device in a series may flash after one second, a second output device may flash after two seconds, a third output device may flash after three seconds, and so forth to create an illusion of movement.

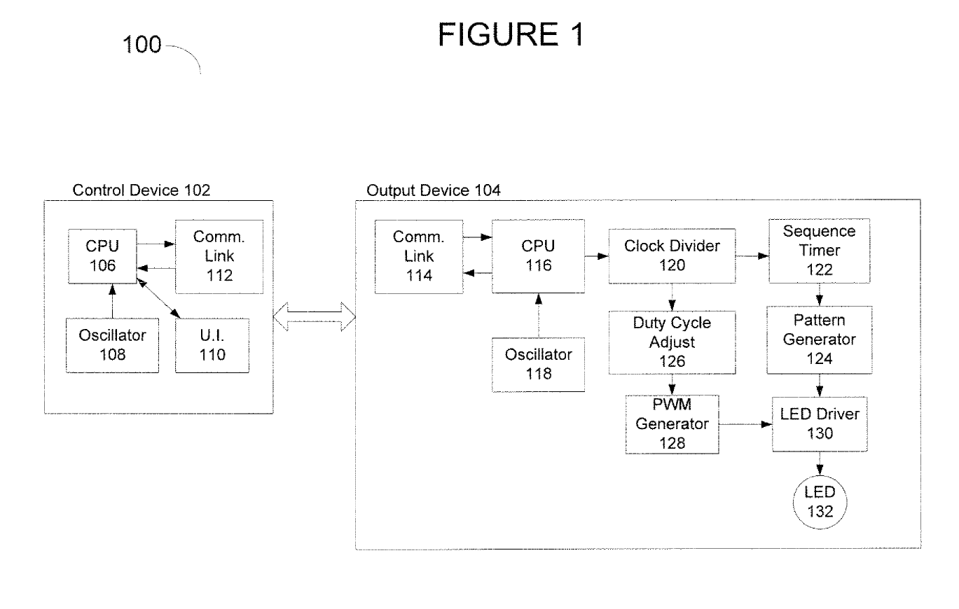

In an alternative embodiment, multicolored LEDs in an output device may function as a single multicolor programmable pixel. When the programmable pixels are used in combination with multiple output devices, full color animated images may be produced for large outdoor graphic displays. The graphics may be generated on a custom computer program, downloaded to the control device, and then transmitted to the individual output devices. A more detailed discussion of the control device and the output devices is presented in the discussions of FIGS. 1-6 below.

FIG. 1 illustrates an exemplary notification system 100. The notification system 100 may include a control device 102 and an output device 104. The control device may include a central processing unit (CPU) 106 operably connected to an oscillator 108, a user interface 110 and a communication link 112. The control device 102 may be a storage case with individual receptacles for each output device 104 such that a communications link is established between the control device and the output device when the output device is placed into the control device. The control device may have a keyboard with a display screen or other similar user interface 110. A user may program the control device 102 via the user interface 110, thereby selecting or defining a pattern to be displayed on a plurality of output devices 104. Once a pattern is defined, the CPU 106 may create an operation sequence unique to each output device 104 based on its serial number, or create a common operational sequence shared by all output devices that each output device may or may not execute differently based on its serial number, or create a command to execute a numbered pre-stored sequence that each output device has pre-loaded that may or may not execute differently based on its serial number. The CPU 106 may transmit the operational sequence, along with a master clock signal produced by the oscillator 108, via the communications link 112 to each output device 104.

A CPU 116 of the output device 104 may receive the operational sequence along with the master clock signal via communications link 114. The individual communication links 112 and 114 may communicate using a wireless connection such as an infrared (I/R) connection, a Bluetooth connection, or other similar short range connections. For exemplary purposes only, the notification systems discussed herein utilize an I/R connection.

Using the master clock signal, the CPU 116 may synchronize a local oscillator 118 to the master clock signal. The copied master clock signal may be passed to a clock divider 120 which may create multiple copies of the master clock signal. A first copy of the master clock signal may be passed to a sequence timer 122 which may compare the master clock signal to the operational sequence. After comparing, the operational sequence and the master clock signal may be passed to a pattern generator 124 which may determine, based upon the serial number of the output device 104, the pattern that the output device should display. The pattern generator 124 may create a local pattern indicating the output be produced by an output device, and pass this to an output driver, such as LED driver 130.

A second copy of the master clock signal may be passed to a duty cycle adjust device 126. Based upon the master clock signal, the duty cycle adjust device 126 may adjust the output of a pulse width modulation (PWM) generator 128 such that the output of the PWM generator is synchronized with the master clock signal to produce a synchronized PWM signal. The synchronized PWM signal output may be passed to the LED driver 130, thus using a PWM driving technique to drive LED 132. By using a PWM driving technique to drive LED 132, the CPU 116 may vary the average power of the LED, thus limiting current to the LED and controlling the brightness of the LED. The PWM generator 128 may create a wave form of varying duty cycle. This wave form may go, for example, from 0% to 100% in 255 increments. The output of the PWM generator 128, passed to the LED driver 130, may switch the LED 132 on and off based upon the PWM duty cycle as well as the local pattern to output. As such, an LED 132 may be driven to produce the appropriate output pattern in sync with the master clock signal. By synchronizing the PWM signal to the master clock at each output device 104, each output device may display the operational sequence in sync.

The PWM driving technique may have several advantageous. For example, the output of the individual LEDs may be increased for a short burst of time. An LED's maximum power depends on several factors such as current and heat which may build as the LED remains on. In this example, when the LED 132 is first turned on, it may begin at the highest allowable current used on the manufacturers guidelines for the LED being used. Using a firmware management system, the duty cycle may be reduced as a ratio of LED time on versus LED time off increases, and alternatively, the duty cycle may be increased as the ratio of LED time on versus LED time off decreases. Thus, the varying of the duty cycle may reduce the brightness of the LED (by reducing maximum power delivered to the LED), thus decreasing heat.

Another exemplary advantage may be a variance in the power supply voltage used. As a battery discharges, its voltage level drops, thereby lowering available current. In a fixed system, LED output light would drop along with the current. In this example, the voltage of a supply battery may be monitored by the CPU 116. As the voltage drops, the duty cycle may be increased such that the maximum power to the LED 132 may be maintained, resulting in constant output light despite changes in supply battery voltage.

Another exemplary advantage may be light output by the LED may be reduced when the output device is located in the control device. When the individual output devices are programmed in the control device, the pattern may be shown to an operator using a low level of light as maximum brightness may be painful to the eye at so close a range. When the output devices are removed from the control device, and after a designated amount of time has passed, the light output may be set to the highest brightness level.

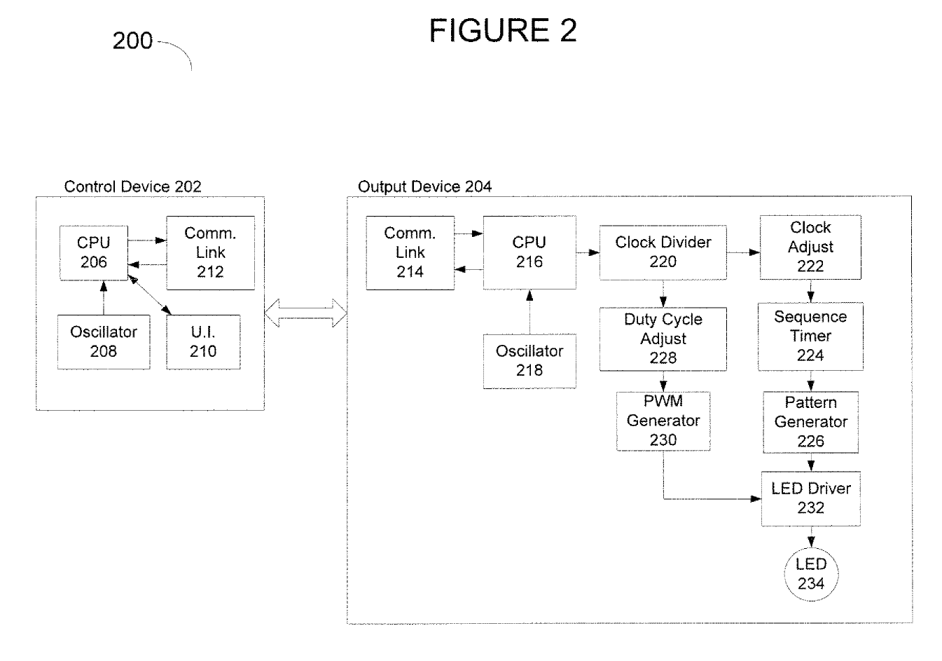

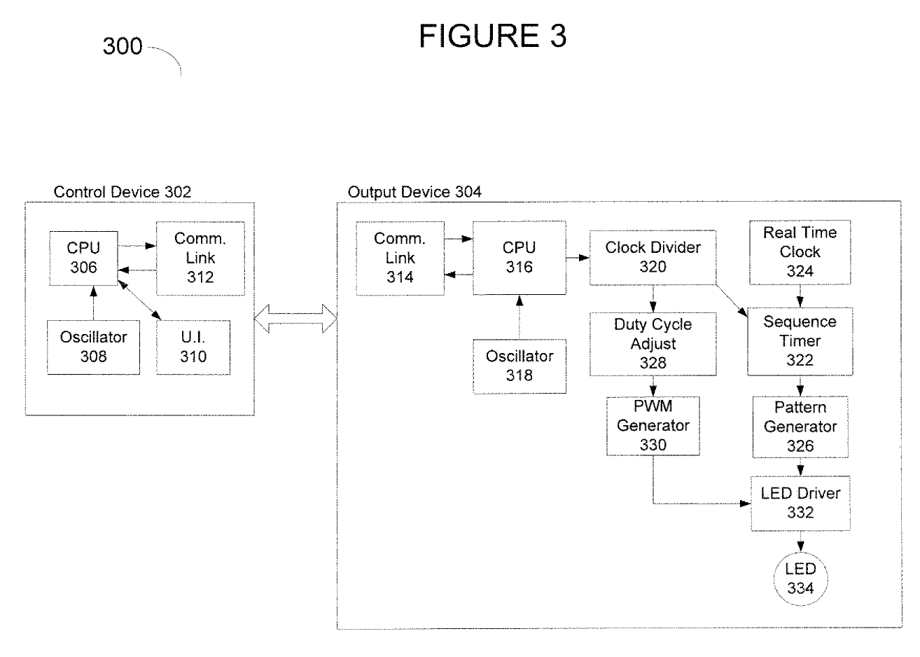

It should be noted that the notification system 100 does not incorporate any clock adjustment components, and therefore a high quality fixed frequency oscillator 118 may be used in each output device to ensure the local version of the master clock at the output device maintains a high level of accuracy. To reduce the cost associated with a fixed frequency oscillator, clock adjustment components or circuits may be included. Two examples are discussed below in regard to FIGS. 2 and 3.

FIG. 2 illustrates an exemplary notification system 200 that is similar to notification system 100 discussed above. The notification system 200 may include a control device 202 and an output device 204. The control device may include a CPU 206 operably connected to an oscillator 208, a user interface 210 and a communication link 212. A user may program the control device 202 via the user interface 210, thereby selecting or defining a pattern to be displayed on a plurality of output devices 204. Once a pattern is defined, the CPU 206 may create an operational sequence including the various serial numbers of the output devices 204 and the function each output device, as defined by its serial number, is to perform. The CPU 206 may transmit the operational sequence, along with a master clock signal produced by the oscillator 208, via the communications link 212 to each output device 204.

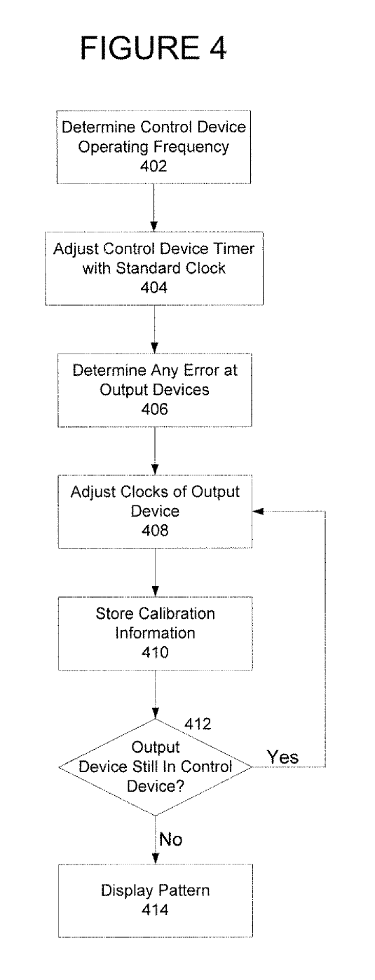

A CPU 216 of the output device 204 may receive the operational sequence along with the master clock signal via communications link 214. Using the master clock signal, the CPU 216 may synchronize a local oscillator 218 to the master clock signal. The copied master clock signal may be passed to a clock divider 220 which may create multiple copies of the master clock signal. A first copy of the master clock signal may be passed to a clock adjust circuit 222. The clock adjust circuit may be included in software or firmware included in each output device 204. The clock adjust circuit may determine any differences between the output produced by the local oscillator 218 and the control device oscillator 208 and adjust the master clock signal accordingly, thereby providing a higher level of clock synchronization. Synchronization of the control device clock and the output device clock is discussed in greater detail in the discussion of FIG. 4. After adjusting, the clock adjust circuit 222 passes the master clock signal to a sequence timer 224 which may compare the master clock signal to the operational sequence. After comparing, the operational sequence and the master clock signal may be passed to a pattern generator 226 which may determine, based upon the serial number of the output device 204, the pattern that the output device should display. The pattern generator 226 may create a local pattern indicating the output to be produced by the output device, and pass this to an output driver, in this example, LED driver 232.

A second copy of the master clock signal may be passed to a duty cycle adjust device 228. Based upon the master clock signal, the duty cycle adjust device 228 may adjust the output of a pulse width modulation (PWM) generator 230 such that the output of the PWM generator is synchronized with the master clock signal to produce a synchronized PWM signal. The synchronized PWM signal output may be passed to the LED driver 232, thus using a PWM driving technique to drive LED 234. As before, by using a PWM driving technique to drive LED 234, the CPU 216 may vary the average power of the LED, thus limiting current to the LED and controlling the brightness of the LED. The PWM generator 230 may create a wave form of varying duty cycle. This wave form may go, for example, from 0% to 100% in 255 increments. The output of the PWM generator 230, passed to the LED driver 232, may switch the LED 234 on and off based upon the PWM duty cycle as well as the local pattern to output. As such, an LED 234 may be driven to produce the appropriate output pattern in sync with the master clock signal. By synchronizing the PWM signal to the master clock at each output device 204, each output device may display the operational sequence in sync.

FIG. 3 illustrates an exemplary notification system 300 that is similar to notification system 200 as discussed above. The notification system 300 may include a control device 302 and an output device 304. The control device may include a CPU 306 operably connected to an oscillator 308, a user interface 310 and a communication link 312. A user may program the control device 302 via the user interface 310, thereby selecting or defining a pattern to be displayed on a plurality of output devices 304. Once a pattern is defined, the CPU 306 may create an operational sequence including the various serial numbers of the output devices 304 and the function each output device, as defined by its serial number, is to perform. The CPU 306 may transmit the operational sequence, along with a master clock signal produced by the oscillator 308, via the communications link 312 to each output device 304.

A CPU 316 of the output device 304 may receive the operational sequence along with the master clock signal via communications link 314. Using the master clock signal, the CPU 316 may synchronize a local oscillator 318 to the master clock signal. The copied master clock signal may be passed to a clock divider 320 which may create multiple copies of the master clock signal. A first copy of the master clock signal may be passed to a sequence timer 322. The sequence timer 322 may compare the master clock signal to an output of a real time clock 324 and determine whether the master clock signal should be adjusted to maintain synchronization with the output of the real time clock. The sequence timer 322 may adjust the master clock signal appropriately. After adjusting, the sequence timer 322 may compare the master clock signal to the operational sequence. After comparing, the operational sequence and the master clock signal may be passed to a pattern generator 326 which may determine, based upon the serial number of the output device 304, the pattern that the output device should display. The pattern generator 326 may create a local pattern indicating the output to be produced by the output device, and pass this to an output driver, in this example, LED driver 332.

A second copy of the master clock signal may be passed to a duty cycle adjust device 328. Based upon the master clock signal, the duty cycle adjust device 328 may adjust the output of a pulse width modulation (PWM) generator 330 such that the output of the PWM generator is synchronized with the master clock signal to produce a synchronized PWM signal. The synchronized PWM signal output may be passed to the LED driver 332, thus using a PWM driving technique to drive LED 334. As before, by using a PWM driving technique to drive LED 334, the CPU 316 may vary the average power of the LED, thus limiting current to the LED and controlling the brightness of the LED. The PWM generator 330 may create a wave form of varying duty cycle. This wave form may go, for example, from 0% to 100% in 255 increments. The output of the PWM generator 330, passed to the LED driver 332, may Switch the LED 334 on and off based upon the PWM duty cycle as well as the local pattern to output. By synchronizing the PWM signal to the master clock at each output device 304, each output device may display the operational sequence in sync.

One important function of the notification systems as discussed above may be the ability to maintain accurate flashing rates several hours after the output devices have been programmed. Synchronization may be accomplished through hardware, but this may require an especially precise timing circuit and production calibration equipment/procedures. Rather, as discussed above, the notification systems may use a device specific synchronization process, as is outlined in FIG. 4.

Initially, the process may determine 402 the operating frequency of the control device. The exact frequency of each control device and the output devices may depend on deviations in board capacitance, component manufacturing tolerances, and assembly variances that may cause the frequencies of the individual output devices to differ from each other as well as from the control device. For exemplary purposes, a 2.048 ms interrupt may be used as the operational frequency of the control device. It should be noted is not important what the exact frequency is, rather that all output devices run at a similar frequency during an operational time. The notification system may use the frequency of the control device to set the standard frequency of all output devices during operation. In other words, the output devices may mach the frequency of the control device from which they are programmed.

Every 125 interrupts (roughly 250 ms), the timer may adjust 404 by a count value that brings the timer in synch with a standard clock. The adjustment may be a 16-bit signed value that is added to the interrupt timer at the point of interrupt. If the crystal frequency of the standard clock is slower than that of the control device, the adjustment value may be a positive number that results in the next interrupt occurring sooner. If the crystal frequency is faster than the control device, the adjustment value may be negative delays the next interrupt. An exemplary operational requirement may be that the output devices remain accurate to within 100 ms over 12 hours. To meet this exemplary operational requirement, the output devices may be adjusted to within 575 ns if the adjustment is made every 250 ms. Since the timer is running at the crystal frequency, the adjustment may provide for a variance from as little as 31.25 ns (to as much as 1.024 ms) every 250 ms, resulting in an acceptable level of tolerance. For this reason, the 250 ms adjustment periods may be chosen.

To determine the adjustment, a separate calibration mode may be performed whenever the output devices are placed in the control device and the control device is on. The control device may continually broadcast a master time signal. The master time signal may be a 3-byte counter value which is simply a free-running counter incremented every interrupt. The output devices may monitor the time passed, and compare the value of the time passed against its internal timer value. In a perfect closed system, this time may be broadcast to the output devices as an exact time value. However, since I/R may be used for communications, there may be a resulting latency from when the control device broadcasts the time and when the output devices receive the time and, depending on the strength of each individual I/R connection, this latency may vary between individual output devices.

To mitigate the varying latency, the output devices may examine the time over a long measurement period, and rather than simply compare the times, the output devices may determine 406 and compare the time error for calibration. After an initial time reading, subsequent time broadcast values may be subtracted from the initial (base) time value. If the difference is positive, the output device clock may be behind the control device master clock. A negative difference may indicate that the output device is running faster than the control device.

Determining whether the output device timer is ahead of or behind the control device timer may be irrelevant. In contrast, determining the movement of the error over time may be of primary relevance. At a subsequent time broadcast, the current error may be compared to the previous error. The following represent four possible results from this comparison:

(1) Signs of two errors are different. If the signs of the two errors are not the same then no adjustment may be made. When properly calibrated the error may oscillate around 0 and an adjustment may be meaningless.

(2) Signs of two errors are both positive. A positive error may indicate that the output device clock is behind the control device master clock. If the previous error is less than the current error, it may indicate that the error is increasing, and that the output device is running slower than the control device. If the previous error is greater than the current error, it may indicate that the output unit is running faster than the control device.

(3) Signs of two errors are both negative. A negative error may indicate that the output device clock is ahead the control device master clock. If the previous error is less than the current error, it may indicate that the error is increasing and that the output device may be running faster than the control device. If the previous error is greater than the current error, it may indicate that the output device is running slower than the control device.

(4) Difference in the errors <4 ms. To mitigate the errors of latency of the I/R, the error may accumulate such that it is greater than 2 counts (4 ms). A single count error may be ignored.

After the above test, it may be known whether the output device is running faster or slower than the control device, and the clock of the output device may be adjusted 408 accordingly. If the output device is running faster than the control device, then the 250 ms adjustment value is decreased. If the output device is running slower than the control device, then the 250 ms adjustment value is increased.

The amount by which the adjustment is changed may initially be relatively large, but may be reduced as the turning between an output device and the control device becomes more accurate. If the output device is running faster than the control device and, after the change in adjustment, the output device is still running faster than the control device, the same change amount may be applied at the next adjustment period. Similarly, if the output device is still running slower than the control device after the adjustment change, the same change amount may be applied at the next adjustment period. If after an adjustment period the output device changes from faster to slower or from slower to faster than the control device, then the adjustment change may be reduced in half. This reduction may continue until the adjustment change amount is 1, which may be the minimum exemplary 31.25 ns change that may be made.

As the output device speed becomes closer to that of the control device, the time required to determine whether or not there is a difference may become increasingly long. At the lowest resolution (i.e., when the adjustment change is 1 (meaning 31.25 ns every 250 ms)) it may take over 10 hours for a single adjustment. However, the adjustment resolution needed to meet the exemplary operational requirements may take far less time and usable calibration may occur within about 8 hours. In any case, the longer the output device remains in the control device, the more accurate the calibration may become. Each output device may store 410 any related calibration numbers in a non-volatile memory, thus they do not need to be specifically calibrated prior to each use. If an output device determines 412 that it is still in the control device, the clock of the output device may continue to adjust 408, thereby resulting in a higher level of calibration. If the output device is removed from the control device, the output device may display 414 an appropriate pattern as discussed above.

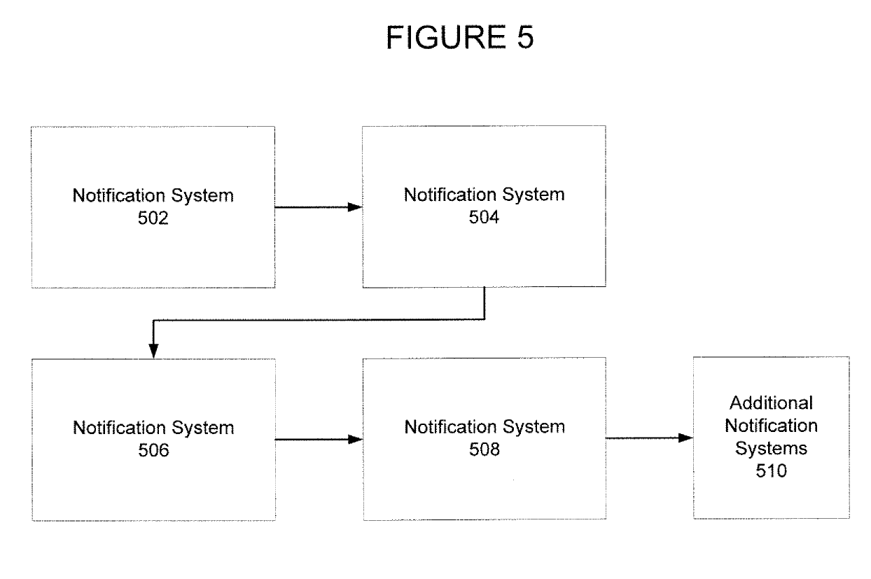

FIG. 5 illustrates an exemplary embodiment where multiple notification systems are connected such that they may be programmed as a single notification system. For example, notification system 502 may be operably connected to notification system 504, which may be operably connected to notification system 506, which may be operably connected to notification system 508, which may be operably connected to additional notification systems 510. Through this arrangement, a single notification system may have a large number of individual output devices. Assuming that each individual notification system (e.g., the notification system 502) includes 15 output devices, linking ten individual notification systems together may result in a single notification system having 150 output devices. The operable connections may be a wired connection or, depending on the capabilities of the individual notification systems, a wireless connection. Additionally, it should be noted that the number of output devices discussed in relation to each individual notification system is shown by way of example only.

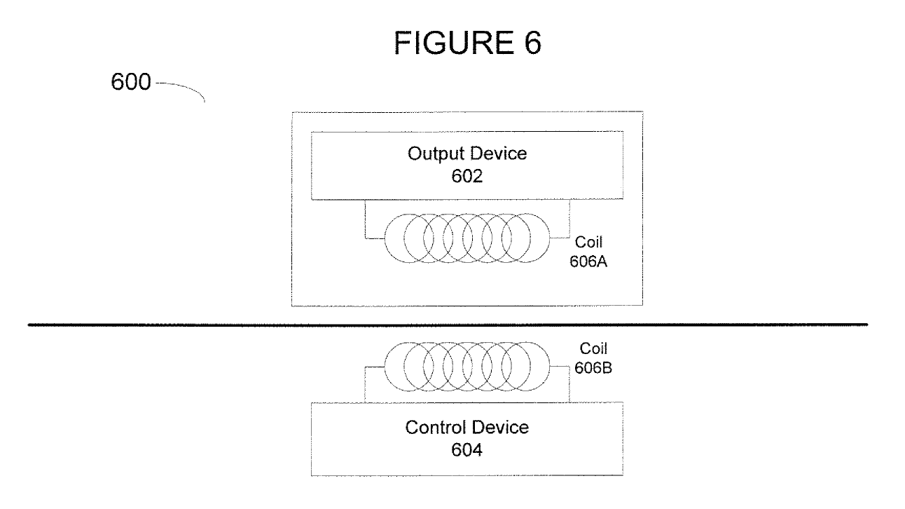

FIG. 6 illustrates an exemplary battery charging arrangement 600. In this example, an output device 602 is placed on or near control device 604. The control device may transmit a charging current to the output device 602 via a set of induction coils 602A and 602B. In the above examples discussed in regard to FIGS. 1, 2 and 3, a dedicated communication link may be used to transmit the operational sequence and the master clock signal. To reduce components, the induction coils 602A and 602B may be used to transmit the operational segue the master clock signal as well as the charging voltage, thus eliminating the additional communication link.

As an alternative to utilizing a user-programmable control device, the individual out devices may be calibrated during factory assembly, but synchronizing any pattern generations using an external triggering mechanism that may not require a CPU or a communications link. By using an electromagnetic switching system (e.g., magnets and reed switches), any number of output devices may be synchronized to begin flashing a preset pattern without any communication with a control device. By opening a top of a storage case containing a number of the output devices, or pressing a start button apparatus operably connected to the output devices, a magnet is simultaneously distanced from the reed switch such that all units are triggered at the same time. By utilizing switch mechanisms on both sides of an output device, a method of changing the brightness may be achieved when the output device is removed from a storage case. The output devices may flash at low brightness through a PWM method such as the one described above. When the output devices are removed from the storage case, a second magnet may be separated from a second reed switch, thereby signaling the device to begin flashing in full brightness. This second switch method also may provide means for inserting the output devices in the storage case whereby the orientation or the individual output devices is unimportant. It should be noted it is not necessary to have switching mechanisms on both sides of an output device to realize the final result of synchronized flashing. Whether as a storage case or some other holder, all that may be utilized to achieve synchronized flashing is a switch mechanism that triggers each output device at the same time. The use of magnets and reed switches has an advantage as the output devices can be hermitically sealed and more suitable for hazardous environments than a system of a physical switch that may require a breach of the case to be mounted. It should be noted that switches can be hermetically mounted and hazardous environment use can be achieved by either design discussed above.

The disclosed individual output devices may have a variety of applications. A series of output devices configured to function as electronic flares placed on the ground may control traffic at an accident scene or through a construction zone, direct crowd movement in large gatherings such as concerts or trade shows, or function as helicopter landing zone lights. Placed on a higher surface, such as a wall, the output devices may function as a crowd attraction at trade shows, as a seasonal (e.g., a Christmas or Halloween) lighting decoration or as large animated graphics (e.g., an animated arrow, basic animated graphics display, a large text display). In occasions where the output devices may be used away from the control device for a long period of time, at least one of the output device may be configured to broadcast a version of the master clock, thereby functioning as a remote master device, such that each output device may reset, thereby re-synchronizing the output devices.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for producing a notification comprising:
a control device comprising:
a processor,
a master clock operably connected to the processor and configured to produce a master clock signal,
a user interface operably connected to the processor and configured to generate an operational sequence based upon a user input, and
a transmitter operably connected to the processor and configured to transmit the master clock signal and the operational sequence; and
a plurality of output devices configured to receive the master clock signal and the operational sequence via a connection established by the control device, and to produce a synchronized notification based upon the master clock signal and the operational sequence.

2. The system of claim 1 wherein the plurality of output devices comprise a plurality of devices configured to output a light.

3. The system of claim 1 wherein the plurality of output devices comprise a plurality of devices configured to output a plurality of multi-colored lights.

4. The system of claim 2 wherein the operational sequence comprises a set of instructions instructing each of the plurality of output devices to output the light at a particular time corresponding with the master clock signal.

5. The system of claim 4 wherein the plurality of output devices comprise a plurality of electronic flares configured to direct traffic.

6. The system of claim 2 wherein an output device is further configured to output a sound.

7. The system of claim 1 wherein the control device is configured to establish a wireless connection with the plurality of output devices.

8. The system of claim 7 wherein the control device is further configured to establish a unique wireless connection with each of the plurality of output devices.

9. The system of claim 1 wherein the control device is configured to establish a wired connection with the plurality of output devices.

10. The system of claim 1 wherein at least one of the plurality of output devices comprise a remote master device configured to reset the master clock signal.

11. A method for producing a synchronized notification on a plurality of output devices, the method comprising:
establishing a connection between a control device and the plurality of output devices;
receiving user: input at the control device;
generating a master clock signal at the control device;
generating a operational sequence at the control device based upon the user input;
transmitting, the master clock signal and the operational sequence from the control device to the plurality of output devices; and
displaying a synchronized notification on the plurality of output devices based upon the master clock signal and the operational sequence.

12. The method of claim 11 wherein the establishing a connection between the control device and the plurality of output devices further comprises establishing a unique connection between the control device and each output device.

13. The method of claim 11 wherein the plurality of output devices comprise a plurality of devices configured to output a light.

14. The method of claim 11 wherein the plurality of output devices comprise a plurality of devices configured to output a plurality of multi-colored lights.

15. The method of claim 13 wherein the operational sequence comprises a set of instructions instructing each of the plurality of output devices to output the light at a particular time corresponding to the master clock signal.

16. The method of claim 15 wherein the plurality of output devices comprise a plurality of electronic flares configured for directing traffic.

17. The method of claim 13 wherein an output device is further configured to output a sound.
